(19) United States
(12) Patent Application Publication
(10) Pub. No.: US 2002/0111730 A1
(43) Pub. Date: Aug. 15, 2002

(54) Mechatronics pressure sensor and contact

(76) Inventors: Michael D. Thorum, Lake Orion, MI (US); Helmut Gander, Rochester, MI (US)

Correspondence Address: LAURA M. SLENZAK, SIEMENS CORPORATION, 186 WOOD AVENUE SOUTH, ISELIN, NJ, 08830, US

(21) Appl. No.: 10/077,001

(22) Filed: Feb. 15, 2002

Related U.S. Application Data
(60) Provisional application No. 60/269,082, filed on Feb. 15, 2001.
(60) Provisional application No. 60/269,086, filed on Feb. 15, 2001.
(60) Provisional application No. 60/303,213, filed on Jul. 5, 2001.

(51) Int. Cl. G06F 19/00

(52) U.S. Cl. 701/51

(57) ABSTRACT

A control unit (14) for mounting within a vehicle transmission (12) includes a valve body (28) with defining a plurality of fluid passages (42) and a substantially planer surface (44). A flex foil (34) and an electronic control unit (16) attach to the planer surface (44). The flex foil (34) includes a plurality of contact pads (86) that provide for the electrical communication between the electronic control unit (16) and a plurality of electrical components (24, 30) mounted to the valve body (28). The valve body includes a plurality of openings to communicate fluid to the electrical components (24, 30) for control of hydraulic fluid within the fluid passages (42). (FIG. 2).

The present invention claims priority to United States Provisional Patent Application Ser. Nos. 60/269,082 filed on Feb. 15, 2001, 60/269,086 filed on Feb. 15, 2001 and 60/303,213 filed on Jul. 5, 2001.

### BACKGROUND OF THE INVENTION

This invention relates to an attachment arrangement for components mounted within a vehicle transmission, and specifically to a method and device for mounting and controlling electronic components.

A hydraulically operated vehicle transmission is typically equipped with multiple frictional engaging elements such as hydraulic clutches, disks, brakes and the like that are engaged and disengaged by supplying/discharging operating oil to/from the frictional engaging elements. Proper operation and timing of the shift is achieved by optimizing the oil pressure for engagement/disengagement. The detection of the state of the clutch or other such frictional engagement elements is typically achieved by detecting the engaging oil pressure through an oil pressure sensor. The oil pressure sensor communicates with a transmission electronic control unit which commands the gear shift timing.

Ordinarily, the sensor is located within the transmission case which subjects the sensor to an extremely difficult environment. As a result, these components must be connected in a manner which is robust and impervious to the environment within the transmission case. Typically, multiple wire harnesses connect individual sensors to a connector extending through the transmission case. An external wire harness then provides communication between the sensors and the transmission electronic control unit. Only the sensors and their wire connections are located within the transmission case to avoid subjecting the electronic control unit to the difficult environment within the transmission case. The wire connections are routed within the transmission case to avoid multiple moving transmission components. In addition to the weight penalty of multiple wire harnesses, the routing may become rather complex and multiple wire connections may increase the possibility of failure.

Accordingly, it is desirable to provide a compact mounting arrangement for sensors and associated components which are resistant to the environment within a transmission case while minimizing wire connections and providing advantageous mounting versatility.

### SUMMARY OF THE INVENTION

An embodiment of this invention is a control module for controlling a vehicle transmission including a flex foil mounted to a valve body for communicating between electronic components and an electronic control unit mounted to the valve body.

The control module includes a flex foil mounted to a valve body defining fluid passages and an electronic control unit communicating to a vehicle controller through a wire harness. The wire harness is connected to the control unit through a connector. Sensors communicate with the control unit to provide the hydraulic state of the transmission clutch or other frictional engagement elements within the transmission system.

The electronic control unit mounts to a valve body that includes a plurality of flow passages. The electronic control unit communicates with the sensor and solenoids or other electrical components through a flex foil. The flex foil is essentially a flexible circuit board which provides electronic communication between electronic components through multiple circuit traces. A cover is provided to protect the flex foil and the electronic control unit.

The flex foil is attached directly to the valve body and conforms to the shape of the valve body. The flex foil and circuit traces therein correspond to the position of the various sensor and solenoids that are mounted to the valve body. The flex foil includes a plurality of contact pads contacting electrical connections of the pressure sensors and the solenoids.

The cover protects the electronic control unit along with the flex foil from errant contact. The cover includes an integrally molded connector body to which the flex foil is attached to provide electrical communication through the wire harness to the vehicle controller. The flex foil includes a connector portion that attaches to connectors within the connector body to provide electrical contact therebetween.

The pressure sensors are disposed within the cover both to protect the pressure sensors and to aid assembly. Each of the pressure sensors includes an electrical contact that corresponds to a contact pad of the flex foil. The cover mounts to the valve body to cover the flex foil along with the electronic control unit by way of fasteners extending from an underside of the cover. Substantially the cover covers all of the flex foil and the electronic control unit. Portions of the flex foil including contact pads for electrical connection to the various solenoids remain exposed to facilitate subsequent assembly of the solenoids to the valve body.

The solenoids are secured to the valve body and are in fluid communication to control the flow of hydraulic fluid within the passages. Controlling the flow of hydraulic fluid, in turn controls, the selective engagement of the friction elements within the transmission.

Traditionally, the control module unit is not mounted to the valve body, instead the control module is mounted to the transmission valve body. Integrating the control module with the valve body eliminates a number of parts and increases design flexibility to both the motor vehicle manufacturer and the control module supplier.

The invention includes a method of assembling the control unit including the steps of attaching the flex foil and the electronic control unit to the first surface of the valve body. The pressure sensors within the cover are positioned over an opening in the valve body to be in fluid communication with a fluid passage. The free portion of the flex foil is electrically connected to the connector body. The flex foil is welded to pins disposed within the connector body. The pins cooperate with a mating connector of the wiring harness to provide electrical communication to the vehicle controller. Once the electrical connection is made between the flex foil and the pins of the connector body, the connector body is snapped into place within the cover. The cover includes a cavity into which the connector body is snapped that provides protection for the flex foil.

The other electrical components are then assembled to the valve body and placed in electrical contact with exposed contact pads of the flex foil. The assembled control unit is then installed into the transmission to regulate and control hydraulic fluid used to selectively engage the friction disks of the transmission.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a perspective view of a transmission system;

FIG. 2 is a schematic view of the transmission system with a control unit;

FIG. 3 is a view of one side of a valve body;

FIG. 4 is a view of a second side of the valve body;

FIG. 5 is a perspective view of the valve body with a flex foil and cover;

FIG. 5A is a cross-sectional view of a contact pad;

FIG. 5B is a cross-sectional view of a pressure sensor connected to the contact pad;

FIG. 6 is a perspective view of the cover assembled to the valve body;

FIG. 7A is a perspective view of the control unit with solenoids;

FIG. 7B is a cross-sectional view of a mounted solenoid;

FIG. 7C is a partial perspective view of a solenoid and the control unit;

FIG. 8 is perspective view of electrical contacts of the pressure sensores disposed within a carrier;

FIG. 9, is a perspective view of the top of the carrier;

FIG. 10 is a perspective view of the carrier and the base plate including slots;

FIG. 11 is a perspective view of the carrier installed onto the base plate; and

FIG. 12 is a cross-sectional view of the contact between the pressure sensor and the flex foil.

### DETAILED DESCRIPTION OF THE PREFERRED EMBODIMENT

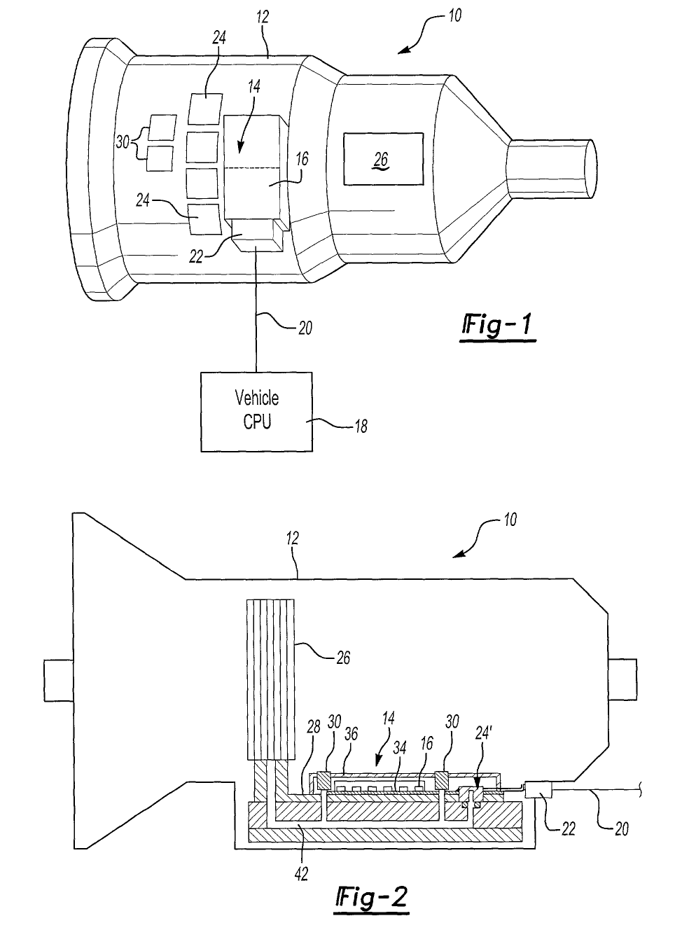

FIG. 1 schematically illustrates a vehicle transmission system 10. The transmission system 10 includes a transmission housing 12 having a mechatronics control module 14 mounted therein. Mechatronics refers to the placement of a circuit board capable of enduring the harsh conditions within the transmission 12. The control module 14 includes an electronic control unit 16 communicating to a vehicle controller 18 through a wire harness 20. The electronic control unit 16 is a circuit board including various electronic components mounted thereon to eliminate the need for multiple wire harness extending within the transmission 12. The wire harness 20 is connected to the control unit 16 through a connector 22. Pressure sensors 24 communicate with the control unit 16 to provide the hydraulic state of the transmission clutch (illustrated schematically at 26) or other frictional engagement elements within the transmission system 10. The pressure sensor 24 as referred to throughout this description includes on/off type pressure switches that provide indicate presence of pressure in the system, and proportional pressure sensors that provide specific pressure level information on pressure within the system.

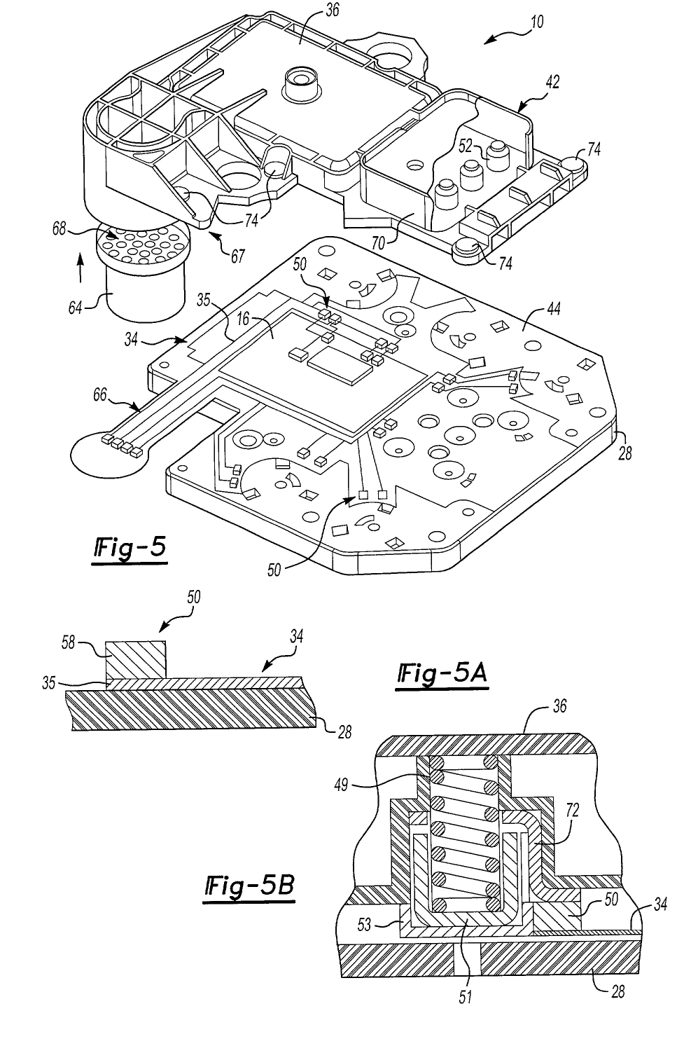

The electronic control unit 16 is preferably mounted to a valve body 28 which includes a plurality of flow passages 42. The electronic control unit 16 preferably communicates with the pressure sensors 24 and solenoids 30 or other electrical components through a flex foil 34. The flex foil 34 is essentially a flexible circuit board which provides electronic communication between electronic components through multiple circuit traces (FIG. 5). The flex foil 34 may be one-sided flex foil or two-sided flex foil. In a one sided flex foil the current traces are accessible only from one side, and in a two sided flex foil electrical communication with the current traces are possible from either side. A cover 36 is provided to protect the flex foil 34, and the electronic control unit 16.

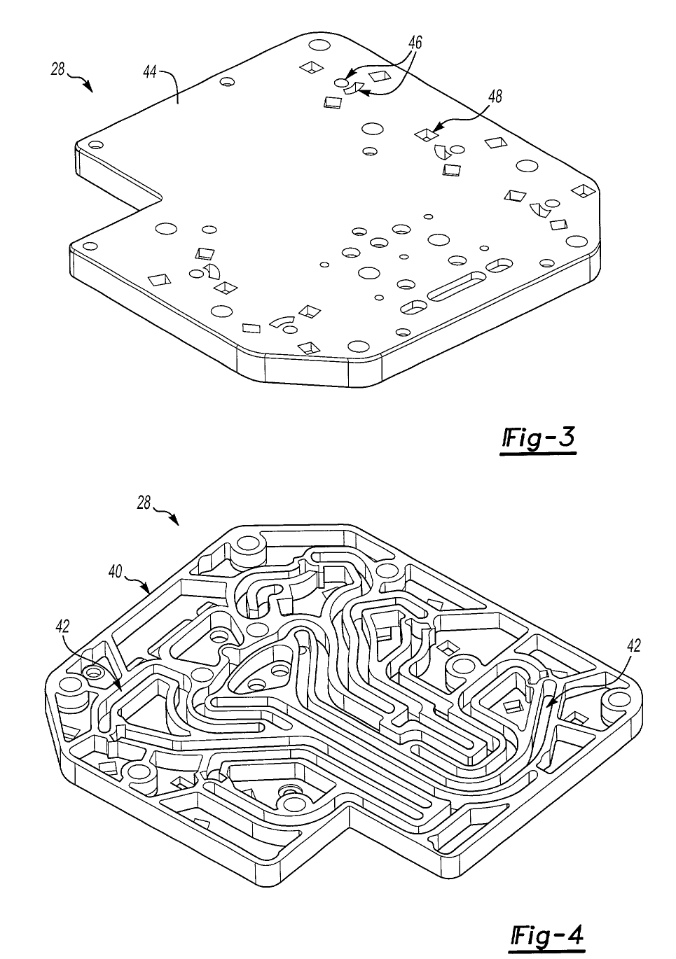

Referring to FIGS. 3 and 4, the valve body 28 includes a first side 40 having a plurality of flow passages 42 that direct hydraulic fluid to engage various friction elements (shown schematically at 26 in FIGS. 1 and 2) within the transmission 12. A second side 44 of the valve body 28 is planer with a specific predetermined flatness and surface finish. The predetermined flatness and surface finish facilitate the mounting of electrical components and the flex foil 34 to the second side 44 of the valve body 28. Along with the flex foil 34, the pressure sensors 24, solenoids 30 and other electrical components are mounted to the second side 44 of the valve body 28 (FIG. 1). A worker knowledgeable in the art would understand that various other electrical components can be mounted to the valve body 28 and are within the contemplation of this invention. The electrical components may include speed sensors, pressure sensores, temperature sensors and any other electrical device known to a worker knowledgeable in the art.

The second side 44 includes a plurality of fluid openings 46 that communicate hydraulic fluid from within the hydraulic passages 42 with electrical components mounted to the valve body 28. Further, the solenoids 30 are secured to the valve body 28 by way of mounting openings 48.

Referring to FIG. 5, the flex foil 34 is attached directly to the second side 44 of the valve body 28. Preferably, the flex foil 34 is bonded to the valve body 28 by an adhesive. The flex foil 34 along with the circuit traces 35 disposed within the flex foil 34 conform to the shape of the valve body 28 and corresponds to the mounting position of the various sensors and solenoids. The flex foil 34 includes a plurality of contact pads 50 to provide electrical connection with the pressure sensors 24 and the solenoids 30. Preferably, the circuit traces 35 are formed from copper; however, other materials as known to a worker skilled in the art are within the contemplation of this invention.

Referring to FIG. 5A, each of the contact pads 50 includes a coating material 58 disposed over the underlying copper circuit trace 35. The purpose of the coating material 58 is to provide a more durable and robust electrical contact point between the circuit trace 35 and the electrical component. Further, the coating 58 inhibits corrosion of the contact pads 50 during assembly and use of the control unit 14.

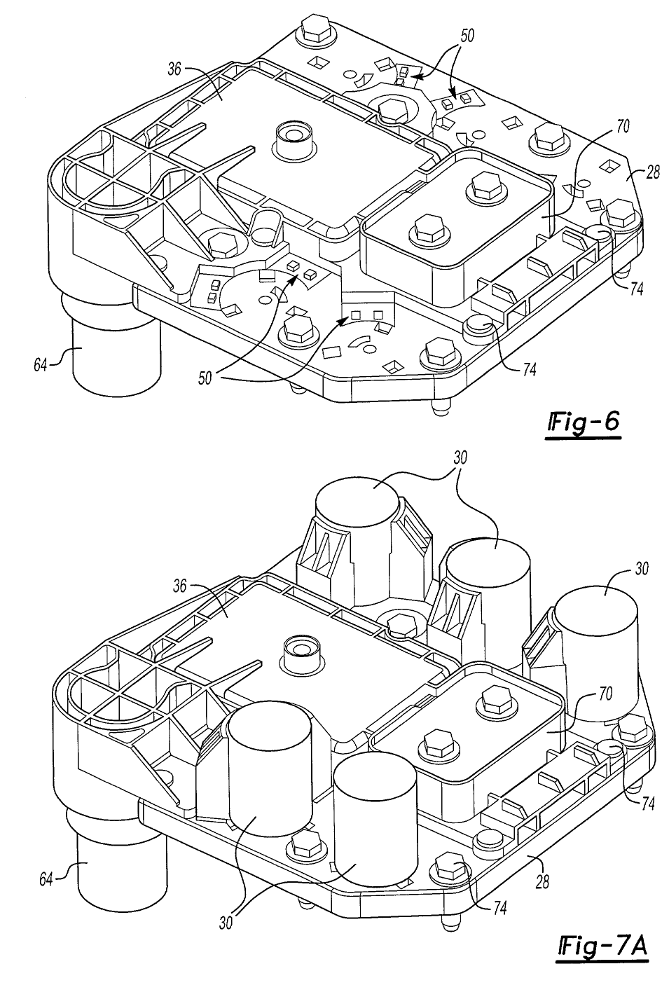

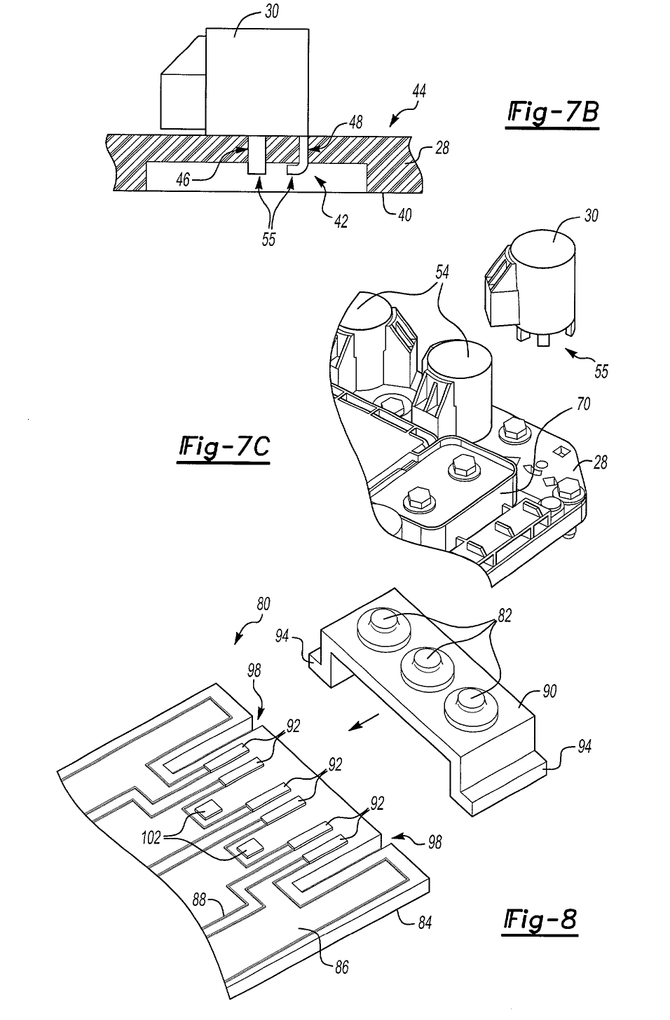

Contact pads 50 that will are electrically attached to the electronic control unit 16 are preferably plated with gold. The gold facilitates the welding of connections to the circuit trace 35. Contact pads 50 that are to contact the solenoids 30, and specifically those that will contact a solenoid 30 (FIG. 7) or pressure sensor 24 through a spring loaded contact 72 are coated in tin. A worker knowledgeable in the art will understand that the specific coating used for the contact pad will depend on the type of electrical connection, i.e. welded or spring loaded contact. Further, other types of coatings that facilitate electrical contact between the flex foil 34 and corresponding electrical components are within the contemplation of this invention.

The cover 36 protects the electronic control unit 16 along with the flex foil 34 from errant contact. As appreciated, the flex foil 34 and the electronic control unit 16 can withstand the harsh environmental conditions within the transmission 12 such as extreme fluctuations in temperature and immersion within hydraulic fluid. The cover 36 protects the electronic control unit 16 and the flex foil 34.

The cover 36 is preferably fabricated from molded plastic to provide a corresponding size and shape to the valve body 28 and the overall dimensions of the control unit 14. The cover 36 includes an integrally molded connector body 64 to which the flex foil 34 is attached to provide electrical communication through the wire harness 20 to the vehicle controller 18. The flex foil 34 includes a connector portion 66 that attached to connectors 68 within the connector body 64 to provide electrical contact therebetween.

The connector body 64 in this embodiment is a separate component from the cover 36 that snap fits into the cover 36 once connectors 68 are attached to the flex foil 34. The separate connector body 64 provides for ease of manufacturing because the connector body 64 can be orientated to facilitate the electrical connection between the connectors 68 and the flex foil 34.

The connector body 64 is configured to correspond to the specific mating connector 22 of the wiring harness 20. A worker knowledgeable in the art will understand that the configuration of the connector body 64 is adaptable to the specific application. Further, although the cover 36 of this embodiment includes only one connector body 64, it is within the contemplation of this invention to include additional connector bodies as is required for specific applications.

The pressure sensors 24 are disposed within a housing 70 integrated within the cover 36. The pressure sensors 24 are disposed within the cover 36, both to protect the pressure sensors 24 and to aid assembly. Each of the pressure sensors 24 includes an electrical contact 72 (FIG. 5B) that corresponds to a contact pad 50 of the flex foil 34. The electrical contact 72 is welded to the flex foil 34. The pressure sensor 24 includes a cup and spring. The cup is pushed upward in response to pressure being communicated up through the valve body 28. Preferably, the electrical contace 72 is laser welded to the flex foil 34 contact pad 50. However, it is within the contemplation of this invention to use any type of electrical contact is known to a worker skilled in the art.

Referring to FIG. 6, the cover 36 mounts to the valve body 28 to cover the flex foil 34 along with the electronic control unit 16 by way of fasteners 74 extending from an underside of the cover 36. In the present embodiment the fasteners 74 are rivets that extend into corresponding openings defined by the surface of the valve body 28. Other types of fasteners such as screws, bolts and the like are within the contemplation of this invention. Substantially all of the flex foil 34 and the cover 36 covers the electronic control unit 16. Portions of the flex foil 34 including contact pads 50 for electrical connection to the solenoids 30 (FIG. 7A) remain exposed to facilitate subsequent assembly of the solenoids 30 to the valve body 28.

A plurality of differently shaped openings within the valve body 28 remain exposed with the cover 36 assembled to the valve body 28. These provide several differing functions. Some of the openings are mounting openings 48 throughwhich extend a mounting bracket 55 for each solenoid 30 (FIG. 7B). The mounting bracket 55 is then crimped onto the valve body 28 to secure the solenoid. Fluid openings 46 correspond to specific flow passages 42 defined by the first side 40 of the valve body 28.

Referring to FIG. 7A-C, the solenoids 30 are secured to the valve body 28 and are in fluid communication to control the flow of hydraulic fluid within the passages 42. Controlling the flow of hydraulic fluid, in turn controls, the selective engagement of the friction elements 26 within the transmission 12 (FIG. 1 and 2). The solenoid 30 cooperates to form a fluid seal between the solenoid 30 and the second side 44 of the valve body 28. The fluid seal prevents undesirable migration of hydraulic fluid from the fluid passages 42. The function fulfilled by each of the solenoids 30 is application specific and it is within the contemplation of this invention to use any type of solenoid. A worker skilled in the art will understand that the type of solenoid installed is application specific, and may include any type of solenoid known to a worker skilled in the art.

The invention includes a method of assembling the control unit including the steps of attaching the flex foil 34 and the electronic control unit 16 to the second surface 44 of the valve body 28. The valve body 28 includes a plurality of openings that extend from the first surface to a plurality of flow passages 42 defined by the first surface 40. the electronic control unit 16 is then wire bonded to specific contact pads 50 of the flex foil 34. The pressure sensors 24 are mounted within the housing 70 of the cover 36. The cover 36 protects the electronic control unit 16 and the flex foil 34. The cover 36 envelops substantially the entire electronic control unit 16 and the flex foil 34. The cover 36 includes a seal to prevent contaminates from seeping in between the cover 36 and the flex foil 34. The pressure sensors 24 within the cover 36 are positioned over the fluid openings 46 and are in fluid communication with one of the plurality of fluid passages 42. The cover 36 is then attached to the valve body 28.

The free portion 66 of the flex foil 34 is electrically connected to connector pins 68 before the connector body 64 is attached to the cover 36. Preferably, the flex foil 34 is laser welded to the connectors 68. The connectors 68 cooperate with the connector 22 of the wiring harness 20 to provide electrical communication to the vehicle controller 18. Once the electrical connection is made between the flex foil 34 and the connectors 68 of the connector body 64, the connector body 64 is snapped into place within the cover 36. The cover 36 includes a cavity 67 into which the connector body 64 is snapped that provides protection for the free portion 66 of the flex foil 66.

The other electrical components (solenoids 30, pressure sensors 24, etc) are then assembled to the valve body 28 and placed in electrical contact with exposed contact pads 50 of the flex foil 34. Preferably, the solenoids 30 are crimped onto the valve body 28 such that each solenoid 30 is in fluid communication with one of the flow passages 42 defined by the first side 40 of the valve body 28 (FIG. 7A). The assembled control unit 14 is then installed into the transmission 12 to regulate and control hydraulic fluid used to selectively engage the friction disks 26 of the transmission 12 (FIGS. 1 and 2). Note that the solenoids 30 may be of any type known in the art.

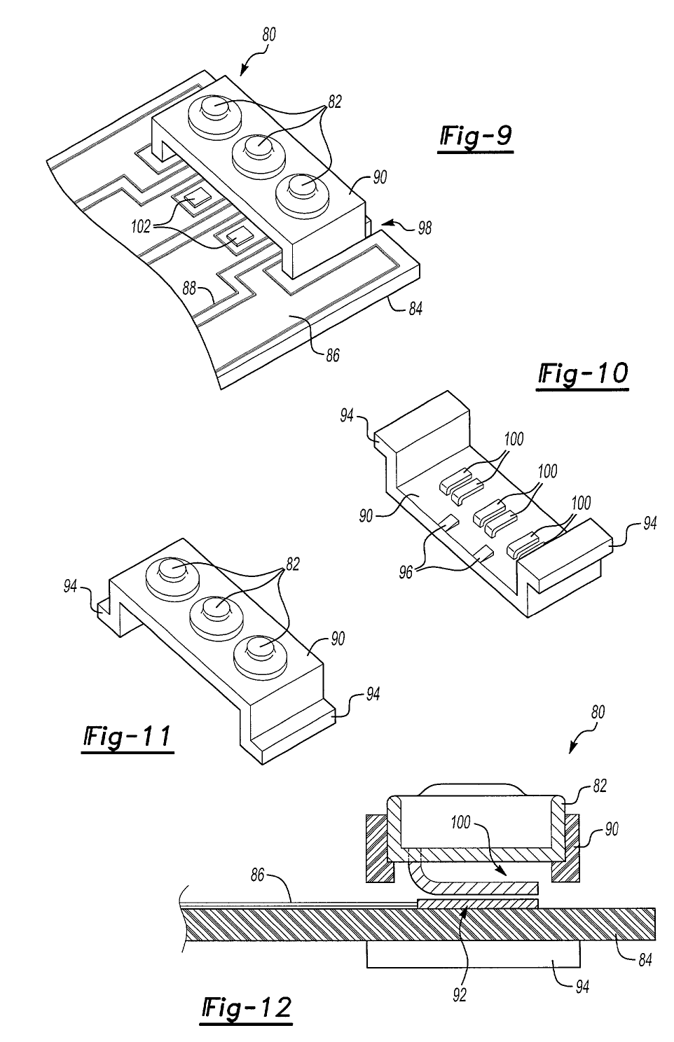

Referring to FIGS. 8 and 9, another embodiment of mounting pressure sensors 82 within the control module 14 is indicated at 80. Flex foil 86 is adhered to abase plate 84. The base plate 84 secures to a valve body (not shown) similar to that disclosed hereinabove. A worker knowledgeable understands how the base plate 84 would be mounted in cooperation with a valve body.

The base plate 84 includes slots 98 that are open to a side of the base plate 84. Pressure sensors 82 are mounted within a carrier 90 having a pair of tabs 94 for engagement to the slots 98 of the base plate 84. The flex foil 86 includes circuit traces 88 in communication with contact pads 92. The contact pads 92 provide an electrical connection between the pressure sensors 82 and the vehicle controller 18 (FIG. 1). The carrier 90 clips into the slots 98 and slides over the contact pads 92. Pressure sensors 82 mounted within the transmission 12 are preferably mounted to operate within the extreme pressure encountered therein. The carrier 90 carrier mounted pressure sensors of this embodiment provide the required support to enable the pressure sensors 82 to function optimally in the harsh environment encountered within the transmission 12.

Referring to FIG. 10 and 11, each of the pressure sensors 82 includes a spring loaded electrical connection 100. The electrical connections 100 extend from each pressure sensors 82 and into electrical contact with contact pads 92 of the flex foil 34.

The carrier 90 includes tabs 94 at distal ends that fit into the slots 98 of the base plate 84. The carrier 90 further includes retaining tabs 96 that engage openings 102 within the base plate 84. The retaining tabs 96 prevent the carrier 90 from sliding off the base plate 84.

FIG. 12 is a cross-section of the electrical connection between the pressure sensors 82 and the contact pads 92 of the flex foil 86. The electrical connection 100 of the pressure sensors 82 includes a copper contact arm extending downward from the pressure sensors 82. The electrical contact 100 is forced upward as the pressure sensor 82 slides onto the base plate 84. The resulting pressure created between the contact pad 92 and the electrical contact 100 provides the required electrical contact with the flex foil 86. Note that as stated herein above, the pressure sensors 82 may be of any type known in the art including on/off and proportional pressure sensors.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A control unit for mounting within a vehicle transmission comprising;
a valve body defining a plurality of fluid passages, and a substantially planer surface;
a flex foil attached to said planer surface and including a circuit trace; and
a component mounted to said valve body and in electrical communication with said circuit trace of said flex foil.

2. The control unit as recited in claim 1, wherein said component is in communication with said fluid passages.

3. The control unit as recited in claim 1, wherein said component includes a pressure sensor.

4. The control unit as recited in claim 1, wherein said component includes a solenoid.

5. The control unit as recited in claim 4, wherein said solenoid includes at least one spring loaded contact in electrical communication with said circuit trace.

6. The control unit as recited in claim 4, wherein said solenoid includes a first and second coil independently actuatable.

7. The control unit as recited in claim 1, wherein said circuit trace includes a plurality of contact pads to provide electrical communication between said circuit trace and said component.

8. The control unit as recited in claim 7, wherein said contact pads include a coating of tin.

9. The control unit as recited in claim 7, wherein said contact pads include a coating of gold.

10. The control unit as recited in claim 1, wherein said flex foil is bonded by an adhesive to said valve body.

11. The control unit as recited in claim 1, wherein said valve body includes a plurality of opening through which said components communicate with said fluid passages.

12. The control unit as recited in claim 11, wherein said flex foil is aligned such that said components are in communication with said fluid passage.

13. The control unit as recited in claim 1, further including a cover disposed over at least a portion of said flex foil.

14. The control unit as recited in claim 13, wherein said cover includes a connector body in electrical communication with said flex foil.

15. The control unit as recited in claim 1, further including a circuit board affixed to said planer surface.

16. The control unit as recited in claim 1, wherein said valve body defines fluid passages within said vehicle transmission.

17. A control unit for mounting within a vehicle transmission comprising;
a base plate;
a flex foil attached to said base plate and including a circuit trace;
a component having a spring loaded electrical contact in communication with said circuit trace.

18. The control unit recited in claim 17, wherein said component is a pressure sensor.

19. The control unit as recited in claim 17, wherein several components are mounted on a carrier and said carrier mounts to said base plate such that each of said components are in electrical communication with said circuit trace.

20. The control unit as recited in claim 19, wherein said base plate includes slots and said carrier includes a snap portion that extends through said slots to secure said carrier to said base plate.

21. The control unit as recited in claim 20, wherein said base plate includes a pair of slots having one end open to a side of said base plate, and said snap portion mounts within said slots.

22. The control unit as recited in claim 21, wherein said carrier includes a locking tab and the base plate includes an opening cooperating with said locking tab to secure said carrier to said base plate.

23. A method of assembling a control unit for mounting within a vehicle transmission comprising the steps of;
a. bonding a flex foil having a circuit trace to a first side of a valve body defining at least one fluid passage;
b. mounting at least one electrical component to said valve body; and
c. connecting said at least one electrical component to said flex foil to provide electrical communication therebetween.

24. The method of claim 23, further including the step of adhering a circuit board to said first side of said valve body and connecting said circuit board to said flex foil to provide electrical communication therebetween.

25. The method of claim 23, further including the step of mounting a cover including a connector to said valve body.

26. The method of claim 25, further including the step of electrically connecting the flex foil to the connector.

27. The method of claim 26, further including the step of assembling the connector to the cover.

28. The method of claim 23, wherein said step of mounting said at least one electrical component is further defined as crimping a portion of said electrical component to said valve body.

29. The method of claim 27, wherein said step of mounting the at least one electrical component is further defined by engaging an electrical connector of the electrical component to a contact pad of the flex foil.
